(19) United States
(12) Patent Application Publication
(10) Pub. No.: US 2025/0257190 A1
(43) Pub. Date: Aug. 14, 2025

(54) COMPOSITION COMPRISING AT LEAST ONE DIALKYL OR PEROXYKETAL PEROXIDE AND AT LEAST ONE UNSATURATED ORGANIC PEROXIDE

(71) Applicant: Arkema France, Colombes (FR)

(72) Inventors: Alfredo DEFRANCISCI, PIERRE-BENITE CEDEX (FR); Jean-Pierre DISSON, PIERRE-BENITE CEDEX (FR); Leonard PALYS, KING OF PRUSSIA, PA (US)

(21) Appl. No.: 19/113,473

(22) PCT Filed: Sep. 21, 2023
(86) PCT No.: PCT/FR2023/051448

§ 371 Date: Mar. 20, 2025

(30) Foreign Application Priority Data
Sep. 21, 2022 (FR) FR2209542

(51) Int. Cl. C08K 5/14; C08J 3/00; C08J 3/22; C08J 3/24; C08K 3/04; C08K 5/3435

(52) U.S. Cl. CPC C08K 5/14; C08J 3/005; C08J 3/22; C08J 3/24; C08K 3/04; C08K 5/3435; C08J 2323/16

(57) ABSTRACT

The present invention relates to a composition comprising at least one organic peroxide selected from the group consisting of dialkyl peroxides, peroxyketals or a mixture thereof and at least one unsaturated organic peroxide. The invention also relates to the use of such a composition for preventing the scorching of at least one crosslinkable composition. The present invention also relates to a method for crosslinking at least one crosslinkable composition comprising at least one crosslinkable polymer. The invention further relates to an article, in particular a moulded article or an extruded article, which can be obtained from the crosslinking method.

### FIELD OF THE INVENTION

The present invention deals with a composition comprising at least one organic peroxide chosen among the group consisting of dialkyl peroxides, peroxyketals and a mixture thereof and at least one unsaturated organic peroxide.

The invention also pertains to the use of such a composition to prevent scorching of at least one crosslinkable composition comprising at least one crosslinkable polymer, preferably chosen among the group consisting of thermoplastic polymers, elastomeric polymers and their mixtures, even more preferably among the group consisting of elastomeric polymers.

The invention further relates to a method for crosslinking at least one crosslinkable composition comprising at least one crosslinkable polymer, preferably chosen among the group consisting of thermoplastic polymers, elastomeric polymers and their mixtures, in the presence of said composition.

In addition, the invention aims at providing an article, especially a moulded or an extruded article, which may be obtained from the method detailed below.

### BACKGROUND OF THE INVENTION

Polymers and copolymers, namely thermoplastic polymers, elastomers and their mixtures, crosslinked with organic peroxides and/or azo compounds generally display better mechanical and physical properties than uncrosslinked polymers or polymers crosslinked by sulfur cure. These properties can include for instance high heat ageing resistance, low percent compression set, decreased staining of metal and easy production of coloured products with enhanced colour stability.

However, premature crosslinking, also designated as scorching, occurring during the preparatory phase represents a major issue in the implementation of organic peroxides and azo compounds in crosslinking (also called curing) applications of elastomeric and/or thermoplastic materials.

The preparatory phase generally consists in blending or compounding the constituents and possibly extruding them at often high temperatures. The operating conditions of this preparatory phase lead very often to the partial decomposition of the peroxide or azo initiator, thus inducing the premature crosslinking reaction with the formation of gel particles in the mass of the polymeric mixture. The presence of these gel particles is responsible for imparting flaws, such as inhomogeneity and surface roughness, to the final product.

As a result, scorching can scale back the plastic properties of the targeted polymeric material, so that it can no longer be transformed, which may result in the loss of the whole batch. In addition, excessive scorching can lead in some instances to the complete shutdown of the extrusion operation.

Several attempts have been developed in order to curb the tendency towards scorching. For example, the addition of a free radical initiator whose half-life time is long has already been proposed. However, the drawbacks ensuing from this implementation are the low productivity due to a long curing and the high energy costs.

Besides, other attempts hinge on using various additives as scorching inhibitors during the crosslinking of polymeric compositions, such as organic hydroperoxides, vinyl monomers, nitrites, aromatic amines, phenolic compounds, mercaptothiazole compounds, sulfides, hydroquinones and dialkyl dithiocarbamate compounds.

Although these additives are used to extend the time for withstanding scorching, they still nevertheless impede the curing time and/or the final crosslinking density and thereby bring about a decrease in the productivity and/or the properties of the final product.

Indeed, the crosslinking density corresponds to an indication of the properties, especially the mechanical properties, of the final product. Thus, a reduction in the crosslinking density is often a token of the mitigation of the mechanical properties of the final product.

Accordingly, there exists a real need to provide compositions which are able to extend the scorch resistance time during the crosslinking of a polymeric composition, especially a thermoplastic and/or an elastomeric composition, without inducing a harmful effect on the curing time and/or the final crosslinking density.

In other words, one of the purposes of the present invention is to provide compositions that are able to crosslink (or cure) efficiently polymeric compositions and bestow at the same time good properties, in terms of physical and/or mechanical properties, to the targeted product.

In particular, one of the goals of the present invention is to retard scorching during the crosslinking of polymeric compositions without inducing a significant loss in crosslinking efficiency.

### DESCRIPTION OF THE INVENTION

The present invention results in particular from the unexpected finding, by the inventors, that blending two classes of organic peroxides at a specific ratio is able to overcome the aforementioned drawbacks.

Therefore, the present invention relates to a composition comprising:
a) at least one organic peroxide (a) chosen among the group consisting of dialkyl peroxides, peroxyketals and mixtures thereof,
b) at least one organic peroxide (b) comprising in its structure at least one unsaturated side chain, said organic peroxide (b) being different to the organic peroxide (a),
c) at least one nitroxide,
wherein the weight ratio between the at least one organic peroxide (b) and the at least one organic peroxide (a) ranges from 0.003 to 0.04.

The composition of the present invention makes it possible to retard scorching during the crosslinking of polymeric compositions, especially thermoplastic and/or elastomeric compositions, without impeding the curing time and/or the crosslinking density.

In other words, the composition according to the present invention can extend the scorch resistance of a polymeric composition during crosslinking and ensure the sustainability of the curing time and/or the crosslinking density.

As a consequence, the composition of the present invention can efficiently be used to crosslink a polymeric composition while conferring good properties, particularly good physical and/or mechanical properties, to the targeted product with a satisfactory productivity.

In particular, the composition of the present invention confers enhanced mechanical properties to the final product, and more particularly an increased resistance to ageing.

The invention also refers to a method for manufacturing the aforementioned composition comprising mixing:
a) the at least one organic peroxide (a) chosen among the group consisting of dialkyl peroxides, peroxyketals and mixtures thereof, and
b) the at least one organic peroxide (b) comprising in its structure at least one unsaturated side chain, said organic peroxide (b) being different to the organic peroxide (a),
c) optionally at least one nitroxide,
   wherein the weight ratio between the at least one organic peroxide (b) and the at least one organic peroxide (a) ranges from 0.003 to 0.04.

The present invention also deals with a method for crosslinking at least one crosslinkable composition comprising at least one crosslinkable polymer, especially chosen among the group consisting of thermoplastic polymers, elastomeric polymers and their mixtures, comprising:
i) optionally mixing said crosslinkable composition in the presence of a composition comprising:
   a) at least one organic peroxide (a) chosen among the group consisting of dialkyl peroxides, peroxyketals and mixtures thereof,
   b) at least one organic peroxide (b) comprising in its structure at least one unsaturated side chain, said organic peroxide (b) being different to the organic peroxide (a),
   wherein the weight ratio between said organic peroxide (b) and said organic peroxide (a) ranges from 0.003 to 0.04, preferably from 0.005 to 0.03, more preferably from 0.01 to 0.025;
ii) curing the obtained mixture.

The method of the present invention allows delaying scorching of said crosslinkable composition without significantly impeding the crosslinking density. In other words, it has been observed that the crosslinking density does not fall during the aforementioned method.

The method according to the invention can make it possible to manufacture an article having good properties, especially good physical and/or mechanical properties, while ensuring a satisfactory productivity.

Therefore, another aspect of the present invention is directed to an article, especially a moulded or an extruded article, capable of being obtained from the previously detailed method.

Another subject-matter of the invention aims at the use of the aforementioned composition to cure at least one crosslinkable composition comprising at least one crosslinkable polymer, especially chosen among the group consisting of thermoplastic polymers, elastomeric polymers and their mixtures, preferably elastomeric polymers.

Advantageously, the use of the composition makes it possible to rein in the risks of scorching of a crosslinkable composition and to control its curing.

Preferably, the aforementioned composition is used to prevent scorching of at least one crosslinkable composition comprising at least one crosslinkable polymer as previously defined.

Other objects and characteristics, aspects and advantages of the invention will emerge even more clearly on reading the description and the examples that follow.

In the text herein below, and unless otherwise indicated, the limits of a range of values are included in that range, in particular in the expressions “between” and “ranging from . . . to . . . ”.

Moreover, the expression “at least one” used in the present description is equivalent to the expression “one or more”.

In the text herein below, the terms “peroxyketal” and “perketal” are equivalent.

Furthermore, the term “polymer” encompasses “homopolymers” and “copolymers”, where the term “copolymers” refers to a polymer composed of at least two different monomers in polymerized form. For example, a copolymer in accordance with the present disclosure may be a polymer comprising two different monomers, a terpolymer is a polymer comprising three different monomers or more.

### Composition

As previously detailed, the composition of the present invention contains in particular at least one organic peroxide (a) chosen among the group consisting of dialkyl peroxides, peroxyketals and mixtures thereof.

The dialkyl peroxides can be chosen among the group consisting of di-t-butyl peroxide; t-butyl cumyl peroxide; 2,5-di(cumylperoxy)-2,5-dimethyl hexane; 4-methyl-4-(t-butylperoxy)-2-pentanol; 4-methyl-4-(t-amylperoxy)-2-pentanol; 4-methyl-4-(cumylperoxy)-2-pentanol; 4-methyl-4-(t-butylperoxy)-2-pentanone; 4-methyl-4-(t-amylperoxy)-2-pentanone; 4-methyl-4-(cumylperoxy)-2-pentanone; 2,5-dimethyl-2,5-di(t-butylperoxy)hexane; 2,5-dimethyl-2,5-di(t-amylperoxy)hexane; 2,5-dimethyl-2-t-butylperoxy-5-hydroperoxyhexane; 2,5-dimethyl-2-cumylperoxy-5-hydroperoxy hexane; 2,5-dimethyl-2-t-amylperoxy-5-hydroperoxyhexane; 1,3-bis(tert-butylperoxyisopropyl)-benzene, 1,4-bis(tert-butylperoxyisopropyl)-benzene; 1,3,5-tris(t-butylperoxyisopropyl)benzene; 1,3,5-tris(t-amylperoxyisopropyl)benzene; 1,3,5-tris(cumylperoxyisopropyl)benzene; di[1,3-dimethyl-3-(t-butylperoxy)butyl]carbonate; di[1,3-dimethyl-3-(t-amylperoxy)butyl]carbonate; di[1,3-dimethyl-3-(cumylperoxy)butyl]carbonate; di-t-amyl peroxide; dicumyl peroxide; t-butylperoxy-meta-isopropenyl-cumyl peroxide; t-amyl cumyl peroxide; t-butyl-isopropenylcumyl peroxide; 2,4,6-tri(butylperoxy)-s-triazine; 1,3,5-tri[1-(t-butylperoxy)-1-methylethyl]benzene; 1,3,5-tri-[(t-butylperoxy)-isopropyl]benzene; 1,3-dimethyl-3-(t-butylperoxy)butanol; 1,3-dimethyl-3-(t-amylperoxy)butanol; and mixtures thereof.

Other dialkyl peroxides which may be used singly or in combination with the other free radical initiators contemplated by the present disclosure are those selected from the group represented by the following formula (I):

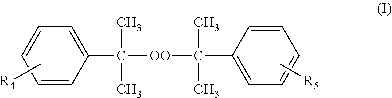

wherein R₄ and R₅ may independently be in the meta or para positions and are the same or different and are selected from hydrogen or straight or branched chain alkyls of 1 to 6 carbon atoms. Dicumyl peroxide and isopropylcumyl peroxide are illustrative.

Preferably, the dialkyl peroxides are selected from the compounds having the following formula (II):

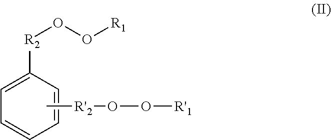

wherein:
R₁ and R′₁, independently from one another, represent a linear or a branched, preferably branched, C₃-C₁₀ alkyl radical,
R₂ and R′₂, independently from one another, represent a linear or a branched, preferably branched, C₃-C₁₀ alkyl radical.

More preferably, according to formula (II):
R₁ and R′₁ are the same and represent a linear or a branched, especially branched, C₃-C₁₀ alkyl radical, and
R₂ and R′₂ are the same and represent a linear or a branched, preferably branched, C₃-C₁₀ alkyl radical.

Even more preferably, according to formula (II):
R₁ and R′₁ represent a branched C₃-C₁₀ alkyl radical, especially a branched C₃-C₆ alkyl radical,
R₂ and R′₂ are the same and represent a branched C₃-C₁₀ alkyl radical, especially a branched C₃-C₆ alkyl radical.

Preferably, the group R′₂—O—O—R′₁ can be in meta or para position on the benzene ring defined in formula (II).

The dialkyl peroxides corresponding to formula (II) are preferably chosen among the group consisting of 1,3-bis(tert-butylperoxyisopropyl)-benzene, 1,4-bis(tert-butylperoxyisopropyl)-benzene, and their mixture.

The dialkyl peroxides are preferably chosen among the group consisting of 2,5-dimethyl-2,5-di(t-butylperoxy)hexane, dialkyl peroxides represented by formula (I), dialkyl peroxides represented by formula (II) and mixtures thereof.

The dialkyl peroxides are preferably chosen among the group consisting of 2,5-dimethyl-2,5-di(t-butylperoxy)hexane, dicumyl peroxide, 1,3-bis(tert-butylperoxyisopropyl)-benzene, 1,4-bis(tert-butylperoxyisopropyl)-benzene, and mixtures thereof.

The dialkyl peroxides are even more preferably chosen among the group consisting of 1,3-bis(tert-butylperoxyisopropyl)-benzene, 1,4-bis(tert-butylperoxyisopropyl)-benzene and their mixture.

The peroxyketals can be chosen among the group consisting of 1,1-di(t-butylperoxy)-3,3,5-trimethylcyclohexane; 1,1-di(t-butylperoxy)cyclohexane; n-butyl 4,4-di(t-amylperoxy)valerate; ethyl 3,3-di(t-butylperoxy)butyrate; 2,2-di(t-amylperoxy)propane; 3,6,6,9,9-pentamethyl-3-ethoxycarbonylmethyl-1,2,4,5-tetraoxacyclononane; n-butyl-4,4-bis(t-butylperoxy)valerate; ethyl-3,3-di(t-amylperoxy)butyrate; and mixtures thereof.

The peroxyketals are preferably chosen among the group consisting of n-butyl-4,4-bis(t-butylperoxy)valerate, 1,1-di(t-butylperoxy)-3,3,5-trimethylcyclohexane and mixtures thereof.

Preferably, the perketal is n-butyl-4,4-bis(t-butylperoxy)valerate.

The organic peroxide (a) is preferably chosen among the group consisting of dialkyl peroxides as previously defined, especially those chosen among the group consisting of 2,5-dimethyl-2,5-di(t-butylperoxy)hexane, dialkyl peroxides represented by formula (I), dialkyl peroxides represented by formula (II) and mixtures thereof.

The organic peroxide (a) is preferably chosen among the group consisting of dialkyl peroxides, especially those chosen among the group consisting of 2,5-dimethyl-2,5-di(t-butylperoxy)hexane, dicumyl peroxide, 1,3-bis(tert-butylperoxyisopropyl)-benzene, 1,4-bis(tert-butylperoxyisopropyl)-benzene, and mixtures thereof, more preferably those chosen among the group consisting of 1,3-bis(tert-butylperoxyisopropyl)-benzene, 1,4-bis(tert-butylperoxyisopropyl)-benzene and their mixture.

The composition according to the present invention further contains at least one organic peroxide (b) comprising in its structure at least one unsaturated side chain.

Preferably, the organic peroxide (b) comprises in its structure at least one side chain containing one or more ethylenic unsaturation, more preferably one ethylenic unsaturation.

Preferably, the side chain is a linear or branched C₂-C₁₀, more preferably C₂-C₄, unsaturated hydrocarbon moiety.

The side chain can be a linear or branched C₂-C₁₀, more preferably C₂-C₄, unsaturated hydrocarbon moiety containing one or more double or triple bonds, preferably at least one double bond.

Preferably, the side chain is a linear or branched C₂-C₁₀, more preferably C₂-C₄, alkylene group containing one or more ethylenic unsaturation, preferably one ethylenic unsaturation.

More preferably, the side chain is an ethylene group.

In other words, the organic peroxide (b) may comprise in its structure a backbone substituted by at least one linear or branched C₂-C₁₀ unsaturated hydrocarbon moiety containing at least one double bond, preferably a linear or branched C₂-C₁₀, more preferably C₂-C₄, alkylene group.

The organic peroxide (b) can be chosen among the compounds having the following formula (III) or (IV):

R₆—O—O—R₆′ (III)

or

R₆′—O—O—R₆′ (IV)

Wherein:
R₆ represents a linear or branched, preferably branched, C₃-C₁₀ alkyl group, preferably C₃-C₆ alkyl group;
R′₆ represents a linear or branched C₂-C₁₂ alkyl group:
   substituted with at least one aromatic ring, especially at least one benzene ring, substituted with at least one side chain, preferably a linear or branched C₂-C₁₀, more preferably C₂-C₄, unsaturated hydrocarbon moiety, containing one or more ethylenic unsaturation, or
   substituted with at least one side chain, preferably a linear or branched C₂-C₁₀, more preferably C₂-C₄, unsaturated hydrocarbon moiety, containing one or more ethylenic unsaturation,
      preferably R′₆ represents a linear or branched C₂-C₁₂ alkyl group substituted with at least one aromatic ring, especially at least one benzene ring, substituted with at least one side chain, preferably a linear or branched C₂-C₁₀, more preferably C₂-C₄, unsaturated hydrocarbon moiety, containing one or more ethylenic unsaturation.

Preferably, R₆ represents a branched C₃-C₁₀ alkyl group, even more preferably a branched C₃-C₇ alkyl group, even more preferably a C₄ group, even more preferably a tert-butyl group.

Preferably, the alkyl group of R₆′ is a linear or branched C₃-C₅ group, even more preferably is a linear or branched C₃ group.

Preferably, the side chain of R₆′ is an isopropenyl, vinyl or allyl group, more preferably is an isopropenyl group.

The aromatic ring of R₆′ can be a C₆-C₁₂ membered ring, preferably a benzene ring.

The organic peroxide (b) is preferably 1-(2-tert-butylperoxyisopropyl)-3-isopropenylbenzene.

The weight ratio between the organic peroxide (b) and the organic peroxide (a) ranges from 0.003 to 0.04, preferably from 0.005 to 0.3, even more preferably from 0.01 to 0.025.

The composition according to the present invention further contains at least one nitroxide.

The nitroxide can be chosen among the group consisting of 2,2,6,6-tetramethylpiperidin-1-oxyl, 4-hydroxy-2,2,6,6-tetramethylpiperidinoxyl, 4-methoxy-2,2,6,6-tetramethylpiperidin-1-oxyl, 4-oxo-2,2,6,6-tetramethylpiperidin-1-oxyl, 2,2,5,5-tetramethylpyrrolidin-oxyl, bis(1-oxyl-2,2,6,6-tetramethyl-piperidin-4-yl) sebacate, 1-piperidinyloxy-4,4′-(1,10-dioxo-1,10-decanediyl)bis(oxy))bis(2,2,6,6-tetramethyl-), 2,2,6,6-tetramethyl-4-hydroxy-piperidine-1-oxyl monophosphonate, 3-carboxy-2,2,5,5-tetramethylpyrrolidinyloxy and mixtures thereof.

The nitroxide is preferably chosen among the group consisting of 2,2,6,6-tetramethylpiperidin-1-oxyl (generally marketed under the name TEMPO), 4-hydroxy-2,2,6,6-tetramethylpiperidinoxyl (generally marketed under the name 4-hydroxy-TEMPO), 1-piperidinyloxy-4,4′-(1,10-dioxo-1,10-decanediyl)bis(oxy))bis(2,2,6,6-tetramethyl-) (commonly called di-TEMPO sebacate) and their mixture.

The nitroxide is preferably 4-hydroxy-2,2,6,6-tetramethylpiperidinoxyl.

The weight ratio between said nitroxide and said organic peroxide (a) preferably ranges from 0.008 to 0.50, more preferably from 0.02 to 0.2 and even more preferably from 0.03 to 0.12.

The composition can comprise at least one organic peroxide chosen from the group consisting of 1,3-bis(tert-butylperoxyisopropyl)-benzene, 1,4-bis(tert-butylperoxyisopropyl)-benzene and their mixture and at least one nitroxide chosen among the group consisting of 2,2,6,6-tetramethylpiperidin-1-oxyl, 4-hydroxy-2,2,6,6-tetramethylpiperidinoxyl and their mixture in a weight ratio ranging from 0.008 to 0.50, more preferably from 0.02 to 0.2 and even more preferably from 0.03 to 0.12.

The weight between said nitroxide and said organic peroxide (b) preferably ranges from 0.05 to 50, more preferably from 0.15 to 16 and even more preferably from 0.5 to 6.

The composition can comprise 1-(2-tert-butylperoxyisopropyl)-3-isopropenylbenzene and at least one nitroxide chosen among the group consisting of 2,2,6,6-tetramethylpiperidin-1-oxyl, 4-hydroxy-2,2,6,6-tetramethylpiperidinoxyl and their mixture in a weight ratio ranging from 0.05 to 50, more preferably from 0.15 to 16 and even more preferably from 0.5 to 6.

The composition can further contain at least one crosslinking promoter, especially chosen from the group consisting of compounds containing at least one double bond which may be bifunctional or polyfunctional, such as for example bifunctional vinyl monomers, bifunctional allyl monomers, polyfunctional vinyl monomers or polyfunctional allyl monomers. These compounds are described in international application WO 02/28946 and make it possible to accelerate the crosslinking rate with no negative impact on the scorch resistance or on the crosslinking density.

The composition according to the present invention can further comprise at least one crosslinkable polymer, preferably chosen among the group consisting of thermoplastic polymers, elastomeric polymers and mixtures thereof, more preferably chosen among the group consisting of elastomeric polymers.

The thermoplastic and/or elastomeric polymers of the present invention may be defined as natural or synthetic polymers which have a thermoplastic and/or elastomeric character and which may be crosslinked (cured) under the action of a cross-linking agent. The crosslinking action and crosslinkable polymers are described in Rubber World, “Elastomer Crosslinking with Diperoxyketals”, October 1983, pages 26-32, and in Rubber and Plastic News, “Organic Peroxides for Rubber Crosslinking”, 29 Sep. 1980, pages 46-50. Polyolefins which are suitable for the present invention are described in Modern Plastics Encyclopedia 89, pages 63-67, 74-75.

The crosslinkable polymer can be selected among the group consisting of low density linear polyethylene, low density polyethylene, high density polyethylene, chlorinated polyethylene, ethylene-propylene-diene terpolymers (EPDM), ethylene-vinyl acetate copolymers, ethylene-propylene copolymers, ethylene-butene copolymers, ethylene-octene copolymers, ethylene-butyl acrylate copolymers (EBA), ethylene-methyl acrylate copolymers (EMA), ethylene-ethyl acrylate copolymers (EBA), silicone rubber, natural rubber (NR), polyisoprene (IR), polybutadiene (BR), acrylonitrile-butadiene copolymers (NBR), styrene-butadiene copolymers (SBR), neoprene rubber (CR), acrylonitrile-butadiene-styrene (ABS), styrene-butadiene-styrene block copolymers (SBS), chlorosulfonated polyethylene, fluoro elastomers, copolymers of ethylene and methyl (meth)acrylate and copolymers of ethylene and glycidyl methacrylate and combinations thereof.

The polymer is preferably an elastomeric polymer, more preferably selected among ethylene-propylene-diene terpolymers (EPDM).

The organic peroxide (a) preferably represents between 1.6 to 4.8 parts, and advantageously between 2 to 4 parts per 100 parts by weight of the crosslinkable polymer.

The organic peroxide (b) preferably represents between 0.015 to 0.8 parts, and advantageously between 0.05 to 0.3 parts per 100 parts by weight of the crosslinkable polymer.

The total content of the organic peroxide (a) and the organic peroxide (b) may represent between 1.62 to 5.6 parts, preferably between 2.05 to 4.3 parts per 100 parts by weight of the crosslinkable polymer.

The nitroxide preferably represents between 0.04 to 0.8 parts, and advantageously between 0.15 to 0.3 parts per 100 parts by weight of the crosslinkable polymer.

Preferably, the composition can comprise:
a) at least one organic peroxide (a) chosen among the group consisting of dialkyl peroxides, especially those among the group consisting of 2,5-dimethyl-2,5-di(t-butylperoxy)hexane, dialkyl peroxides represented by formula (I), dialkyl peroxides represented by formula (II) and mixtures thereof,
b) at least one organic peroxide (b) comprising in its structure at least one unsaturated side chain, especially those chosen among the compounds of formula (III) wherein R′₆ preferably represents a linear or branched C₂-C₁₂ alkyl group substituted with at least one aromatic ring, especially at least one benzene ring, substituted with at least one side chain, preferably a linear or branched C₂-C₁₀, more preferably C₂-C₄, unsaturated hydrocarbon moiety, containing one or more ethylenic unsaturation, said organic peroxide (b) being different to the organic peroxide (a),
c) at least one nitroxide,
wherein the weight ratio between the at least one organic peroxide (b) and the at least one organic peroxide (a) ranges from 0.003 to 0.04;
d) at least one crosslinkable polymer, especially chosen among the group consisting of elastomeric polymers.

According to this aspect, the weight ratio between the organic peroxide (b) and the organic peroxide a) ranges from 0.003 to 0.04, preferably from 0.005 to 0.03, even more preferably from 0.01 to 0.025.

More preferably, the composition can comprise:
a) at least one organic peroxide (a) chosen among the group consisting of 2,5-dimethyl-2,5-di(t-butylperoxy)hexane, dicumyl peroxide, 1,3-bis(tert-butylperoxyisopropyl)-benzene, 1,4-bis(tert-butylperoxyisopropyl)-benzene, and mixtures thereof, even more preferably those chosen among the group consisting of 1,3-bis(tert-butylperoxyisopropyl)-benzene, 1,4-bis(tert-butylperoxyisopropyl)-benzene and their mixture,
b) at least one organic peroxide (b) comprising in its structure at least one unsaturated side chain, especially 1-(2-tert-butylperoxyisopropyl)-3-isopropenylbenzene, said organic peroxide (b) being different to the organic peroxide (a),
c) at least one nitroxide,
   wherein the weight ratio between the at least one organic peroxide (b) and the at least one organic peroxide (a) ranges from 0.003 to 0.040;
d) at least one crosslinkable polymer, especially chosen among the group consisting of elastomeric polymers, even more preferably selected among ethylene-propylene-diene terpolymers (EPDM).

According to this aspect, the weight ratio between the organic peroxide (b) and the organic peroxide (a) ranges from 0.003 to 0.04, preferably from 0.005 to 0.03, even more preferably from 0.01 to 0.025.

### Method for Manufacturing the Composition

Another subject-matter of the present invention aims at a method for manufacturing a composition as previously defined comprising a step of mixing:
a) at least one organic peroxide (a) chosen among the group consisting of dialkyl peroxides, peroxyketals and mixtures thereof,
b) at least one organic peroxide (b) comprising in its structure at least one unsaturated side chain, said organic peroxide (b) being different to the organic peroxide (a),
c) optionally at least one nitroxide,
wherein the weight ratio between said organic peroxide (b) and said organic peroxide (a) ranges from 0.003 to 0.04, preferably from 0.005 to 0.03, even more preferably from 0.01 to 0.025.

### Method for Crosslinking a Crosslinkable Composition

Another aspect of the present invention relates to a method for crosslinking at least one crosslinkable composition comprising at least one crosslinkable polymer, especially chosen among the group consisting of thermoplastic polymers, elastomeric polymers and their mixtures, comprising:
i) optionally, a step of mixing at least one crosslinkable composition comprising at least one crosslinkable polymer in the presence of:
at least one organic peroxide (a) chosen among the group consisting of dialkyl peroxides, peroxyketals and mixtures thereof and
at least one organic peroxide (b) comprising in its structure at least one unsaturated side chain; said organic peroxide (b) being different to the organic peroxide (a),
at least one nitroxide,
wherein the weight ratio between the at least one organic peroxide (b) and the at least one organic peroxide (a) ranges from 0.003 to 0.04,
ii) a step of crosslinking the obtained composition.

The present invention also relates to a method for crosslinking at least one crosslinkable composition comprising at least one crosslinkable polymer, especially chosen among the group consisting of thermoplastic polymers, elastomeric polymers and their mixtures, comprising:
i) optionally, a step of mixing at least one crosslinkable composition comprising at least one crosslinkable polymer in the presence of:
at least one organic peroxide (a) chosen among the group consisting of dialkyl peroxides, peroxyketals and mixtures thereof and
at least one organic peroxide (b) comprising in its structure at least one unsaturated side chain; said organic peroxide (b) being different to the organic peroxide (a),
optionally at least one nitroxide,
wherein the weight ratio between the at least one organic peroxide (b) and the at least one organic peroxide (a) ranges from 0.003 to 0.04,
ii) a step of crosslinking the obtained composition.

In other words, the present invention relates to a method for crosslinking at least one crosslinkable composition comprising at least one crosslinkable polymer, especially chosen among the group consisting of thermoplastic polymers, elastomeric polymers and their mixtures, comprising:
i′) a step of crosslinking said at least one crosslinkable composition in the presence of:
at least one organic peroxide (a) chosen among the group consisting of dialkyl peroxides, peroxyketals and mixtures thereof and
at least one organic peroxide (b) comprising in its structure at least one unsaturated side chain; said organic peroxide (b) being different to the organic peroxide (a),
at least one nitroxide,
wherein the weight ratio between the at least one organic peroxide (b) and the at least one organic peroxide (a) ranges from 0.003 to 0.04.

Thus, the invention relates to a method for crosslinking at least one crosslinkable composition, comprising at least one crosslinkable polymer as defined hereinbelow, comprising:
i′) a step of crosslinking said crosslinkable composition in the presence of a composition as defined hereinabove.

Said crosslinking step may be preceded by a step of mixing:
said crosslinkable composition, and
at least one organic peroxide (a) chosen among the group consisting of dialkyl peroxides, peroxyketals and mixtures thereof and
at least one organic peroxide (b) comprising in its structure at least one unsaturated side chain; said organic peroxide (b) being different to the organic peroxide (a),
at least one nitroxide,
wherein the weight ratio between the at least one organic peroxide (b) and the at least one organic peroxide (a) ranges from 0.003 to 0.04.

The obtained composition comprises said at least one crosslinkable polymer, as previously defined, said at least one organic peroxide (a) chosen among the group consisting of dialkyl peroxides, peroxyketals and mixtures thereof, and said at least one organic peroxide (b) comprising in its structure at least one unsaturated side chain, said organic peroxide (b) being different to the organic peroxide (a), wherein the weight ratio is as described herein below.

In other words, the obtained composition is the mixture obtained in mixing step i) of the method.

Preferably, the method comprises a step of crosslinking the mixture obtained in mixing step i).

The crosslinkable composition preferably comprises at least one crosslinkable elastomeric polymer, more preferably chosen among the group consisting of ethylene-propylene-diene terpolymers (EPDM).

The crosslinkable composition may additionally contain at least one additive such as carbon black filler, process oils, mould release agents, antioxidants and/or heat stabilizers.

The crosslinkable composition may be a polymer masterbatch, preferably an elastomer masterbatch, which may comprise one or more of the aforementioned additives.

Preferably, the polymer masterbatch may comprise at least one elastomer and one or more additives selected from the group consisting of carbon black, polyethylene glycol, at least one process oil (e.g., liquid saturated hydrocarbons, such Primol® 352), at least one antioxidant (e.g. 2,2,4-trimethyl-1,2,-dihydroquinoline, also referred to as TMQ), at least one mould release agent, at least one heat stabilizer, and a combination thereof.

Advantageously, the mixing step can be carried out in any conventional manner.

The curing (or crosslinking) step may be performed at a temperature of between 140° C. and 250° C. and more preferably between 160° C. and 220° C.

The method can further comprise converting the obtained composition (or the mixture obtained in step (i)) into a moulded or an extruded article carried out before, during or after the crosslinking step, preferably before or after the crosslinking step.

The method preferably comprises extruding the obtained composition to form an uncured preformed article and curing the uncured preformed article.

### Use

Another subject-matter of the invention aims at the use of the aforementioned composition comprising a) at least one organic peroxide (a) chosen among the group consisting of dialkyl peroxides, peroxyketals and mixtures thereof and b) at least one organic peroxide (b) comprising in its structure at least one unsaturated side chain, said organic peroxide (b) being different to the organic peroxide (a); wherein the weight ratio between the at least one organic peroxide (b) and the at least one organic peroxide (a) ranges from 0.003 to 0.04, to cure at least one crosslinkable composition, as described herein, comprising at least one crosslinkable polymer.

The crosslinkable polymer is preferably chosen among the group consisting of thermoplastic polymers, elastomeric polymers and their mixtures, more preferably from elastomeric polymers, even more preferably chosen among the group consisting of ethylene-propylene-diene terpolymers (EPDM).

Preferably, the crosslinkable composition is an elastomer masterbatch.

In particular, the aforementioned composition is used to control curing of at least one crosslinkable composition comprising at least one crosslinkable polymer, especially those chosen among the group consisting of thermoplastic polymers, elastomeric polymers and their mixtures, more preferably from elastomeric polymers, even more preferably chosen among the group consisting of ethylene-propylene-diene terpolymers (EPDM).

Preferably, the aforementioned composition is used to prevent scorching of the at least one crosslinkable composition as previously defined.

### Article

The invention also deals with an article, especially a moulded or an extruded article, which may be obtained from the previously defined method.

More preferably, the invention concerns an extruded article obtainable from the aforementioned method.

The article is preferably an elastomeric article.

In other words, the article can be obtained from the method, as previously defined, for crosslinking at least one crosslinkable composition comprising at least one crosslinkable elastomer.

The article is preferably chosen among the group consisting of electric cables or wires.

The examples below are given as illustrations of the present invention.

### EXAMPLES

### I. Tested Initiators

The initiators implemented in the examples described hereafter are listed below:

### A. Organic Peroxide (a) (Component A)

1,3-bis(tert-butylperoxyisopropyl)-benzene (CAS 2212-81-9) was used in the following example.

### Synthesis of Component A

1,3-bis(tert-butylperoxyisopropyl)-benzene

A sample of the peroxide Perkadox® 14S-FL mainly constituted by 1,3-bis(tert-butylperoxyisopropyl)-benzene (CAS 2212-81-9) commercialized by the company Nouryon BV was purified by repeated recrystallization in ethanol.

The purification operation is carried out in a beaker placed in a water bath.

The procedure is as follows:
Solubilize the product to be purified in absolute ethanol.
Allow to stir for about 15 min at a temperature between 45 and 55° C.
Recover the solution in a beaker and cool it to 4° C. by immersing it in a water/ice bath.
Remove most of the solvent by keeping the solid at the bottom of the beaker.
Wash the solid twice with approx. 10/15 g ethanol in the same beaker (for 50 g of treated peroxide).
Repeat the dissolution/crystallization cycle (3 cycles in total).
The product is then filtered on a Büchner funnel with a filter paper on the perforated plate.
The residual ethanol is evaporated from the purified peroxide leaving the sample at room temperature under a ventilated hood for 24 h.

The purified peroxide was analysed by the gas phase chromatography method and presented a content of 1,3-bis(tert-butylperoxyisopropyl)-benzene (CAS 2212-81-9) of 99.8%.

1,3 and 1,4-bis(tert-butylperoxyisopropyl)-benzene

An isomer mixture of 1,3 and 1,4-bis(tert-butylperoxyisopropyl)-benzene (CAS: 25155-25-3) commercialized by the company Sigma-Aldrich/Merk batch no. 09212EN, with a purity of 96% was purified by repeated recrystallization in ethanol.

The purification operation is carried out in a beaker placed in a water bath.

The procedure is as follows:
Solubilize the product to be purified in absolute ethanol.
Allow to stir for about 15 min at a temperature between 45 and 55° C.
Recover the solution in a beaker and cool it to 4° C. by immersing it in a water/ice bath.
Remove most of the solvent by keeping the solid at the bottom of the beaker.
Wash the solid twice with approx. 10/15 g ethanol in the same beaker (for 50 g of treated peroxide).
Repeat the dissolution/crystallization cycle (3 cycles in total).
The product is then filtered on a Büchner funnel with a filter paper on the perforated plate.
The residual ethanol is evaporated from the purified peroxide leaving the sample at room temperature under a ventilated hood for 24 h.

The purified peroxide was analysed by the gas phase chromatography method and presented a content of 1,3-bis(tert-butylperoxyisopropyl)-benzene (CAS 2212-81-9) of 63.0% and a content of 1,4-bis(tert-butylperoxyisopropyl)-benzene (CAS 2781-00-2) of 36.4% for a total amount of mixture of isomers 1,3 and 1,4-bis(tert-butylperoxyisopropyl)-benzene (CAS: 25155-25-3) of 99.4%.

### B. Unsaturated Organic Peroxide (b) (Component B)

1-(2-tert-butylperoxyisopropyl)-3-isopropenylbenzene (CAS 96319-55-0) was used in the following example.

### Synthesis of Component B

The diol (meta isomer from Sumitomo) was dehydrated of one alcohol group using adipic acid (2:1 ratio) at 150° C. for 300 minutes under a vacuum of 40 mbar to extract the water.

The resulting mixture was cooled to 40-50° C. and heptane was added. The aqueous phase was removed and the organic phase was distilled under vacuum of 40 mbar to recover the monoalcohol monoolefin intermediate.

GC-MS analysis revealed a purity above 95%.

This intermediate unsaturated alcohol was reacted with a 45% solution of TBHP in n-heptane (produced by extraction of commercial grade Luperox® TBH70X with n-heptane) in presence of p-toluene-sulfonic acid to produce a mixture containing the monounsaturated dialkyl peroxide.

This mixture was washed with a caustic solution and water in order to remove the unreacted TBHP and acid catalyst.

n-heptane was removed by evaporation in a laboratory evaporator at 50° C. for 2 hours at 40 mbar vacuum.

The final product was then purified on a silica column using acetonitrile as elution solvent.

The eluted fraction containing the desired product was treated on a rotating laboratory evaporator at 50° C. for 2 hours at 40 mbar vacuum until the solvent was removed.

The purified product was analysed by GC-MS analysis which gave us an assay of 99.0%.

### C. Nitroxide (Component C)

4-hydroxy-TEMPO supplied by the company Sigma 3V under the name Tempoxy LO and having a purity of 99.5% was used.

### II. Experimental Protocol

### Procedure for Mixing Rubber and Rubber Sheet Preparation

The following procedure was used for mixing rubber and preparing the rubber compound for crosslinking tests. A Brabender Plasti-Corder® with a 50 ml capacity bowl that is jacketed with the ability to run the mixture at room temperature or with heated oil was used. The mixer was equipped with removable sigma type blades. Small strips of rubber compound “EPDM MB” (see detailed formulation in Table 1) were slowly added to the bowl at a mixing speed of 20 to 25 rpm. The total amount of rubber added to the Brabender Plasti-Corder® bowl was equivalent to the weight needed to provide 48 ml of rubber volume so that there was sufficient volume to add the peroxide curatives to the rubber, as the mixer had a ˜50 ml volume capacity.

Then the mixer rpm was reduced to 15 rpm and the peroxide formulation for that experiment, which was pre-weighed in small Dixie® cups on a minimum of a three place balance for good accuracy, was slowly added to the mixing rubber.

The rpm was then increased back to 25 rpm for three minutes. After this time, the mixer speed was lowered to 10 rpm and the mixer head was unbolted and removed. Once the blades were no longer turning, the rubber around the blades was safely removed and placed on a sheet of Mylar® polyester. There was a small amount of rubber that was located at the head of the mixer blades within the inner hollow portion of the mixing chamber, which was removed last. The mixer head was re-assembled with the bolts and the mixer motor was started again at 20 rpm. The rubber which was removed last, which was trapped in the mixing chamber, was added first to the spinning blades, followed by the rubber that was taken off the blades. This provided for a more uniform mixing of elastomer. The rpm was then increased to 25 rpm and held there for 3 minutes. After this time, the mixer speed was set to 10 rpm and the mixer head unbolted and removed. Once removed, the mixer blade motion stopped and it was again safe to remove all of the rubber from the mixer's bowl and blades.

The warm rubber was then formed into a tight ball and placed between two Mylar® polyester sheets. This sandwich was placed in a warmed hydraulic powered Carver press where the press may be set to between room temperature and 60° C., depending upon the elastomer and the peroxide curatives being used. The ball of rubber was pressed flat between the two heavy Mylar® polyester sheets. Wearing nitrile gloves, the press was opened and the Mylar® polyester sheet sandwich containing the flattened rubber was removed. The top sheet was removed and the rubber was rolled into a tube. This was re-sandwiched and flattened again. The sheet was rolled again, but at 90 degrees to the original roll direction, and flattened again. This operation was repeated a third time, and care was taken to flatten to an approximate thickness of ⅛ inch. The sandwich was placed on the bench top and covered with a metal sheet where the rubber was allowed to cool. It was then removed and stored in a tightly-sealed polyethylene bag. These sheets were then cut with scissors or using a sharp metal circle punch, to make small flat circle sheets of uncured rubber for the rheometer cure and Mooney Scorch evaluations.

### Rheometer Procedures

The following procedure was used for moving die rheometer and RPA (Rubber Process Analyzer) evaluations. For the Alpha Technologies MDR rheometer, test method ASTM D5289-12 “Standard Test Method for Rubber Property—Vulcanization Using Rotorless Cure Meters” was used. Test method ASTM D6204 was used with either a 0.5 degree or 1.0 degree arc and 100 cpm frequency of oscillation at cure temperatures appropriate for the curative system, e.g., 190° C. for the examples below.

When conducting rheometer evaluations, approximately 5 to 6 grams of elastomer (depending upon the density of the final compound) were used to completely fill the upper and lower dies of the rheometer. The uncured rubber was cut from the pressed sheet formed by the procedure described above. The rubber was cut into small round discs about 1.25 inches in diameter and placed between two Dartek® sheets. This sandwich was then placed in the rheometer for testing following standard ASTM D5289.

The measured value indicated as MH-ML is the difference between the maximum value for the torque obtained from the curve recorded by the rheometer expressed as dN m. It indicates the level of crosslinking density.

### Mooney Scorch Procedures

The scorching time (TS05) was measured at 135° C. with the aid of a Mooney MV 2000 viscometer (Alpha Technologies) according to test method ISO 289-2:2020 “Rubber, unvulcanized—Determinations using a shearing-disc viscometer—Part 2: Determination of pre-vulcanization characteristics”

### Example 1

In this example, the EDPM Masterbatch elastomer formulation in Table 1 was mixed with various curing systems and these mixtures were then tested by means of a rheometer and a Mooney Scorch viscometer. Table 2 provides a summary of three cure systems in the EPDM masterbatch formulation.

TABLE 1
“EPDM MB” Masterbatch Formulation

| Ingredient | Phr |
|---|---|
| Vistalon ® 2504 EPDM | 100.0 |
| N550 Carbon Black | 100.0 |
| Primol ® 352 white process oil | 40.0 |
| PEG Polyethylene glycol | 3.0 |
| Stanguard ® TMQ Powder | 1.0 |
| (antioxidant) | |
| Total weight of the masterbatch | 244.0 |

TABLE 2

| | Compo- | Compo- | Compo- |
|---|---|---|---|
| | sition 1 | sition 2 | sition 3 |
| RATIOS | | | |
| C/A | 0.043 | 0.044 | 0.088 |
| B/A | 0.000 | 0.016 | 1.000 |
| COMPOSITION (phr) | | | |
| EPDM MB (g) | 244 | 244 | 244 |
| A - an organic peroxide, 1,3- | 3.2 | 3.15 | 1.60 |
| BIS(TERT- | | | |
| BUTYLPEROXYISOPROPYL)- | | | |
| BENZENE (CAS 2212-81-9) | | | |
| B - an unsaturated organic | 0.00 | 0.05 | 1.60 |
| peroxide, 1-(2-tert-butylperoxyiso- | | | |
| propyl)-3-isopropenylbenzene, | | | |
| C - a nitroxide (4-hydroxy-TEMPO) | 0.14 | 0.14 | 0.14 |
| Ts05 - MOONEY SCORCH at 135° C. | 14:00 | 16:14 | 21:37 |
| change vs reference (%) | | 16% | 54% |
| RPA at 190° C. MH − ML | 23.5 | 23.3 | 20.1 |
| change vs reference (%) | | −1% | −14% |

Results obtained in an EPDM rubber compound containing 3.2 phr of organic peroxides show an improvement in scorch time measured at 135° C. when a mixture of organic peroxides A and B is used, as compared to formulations containing component A as the sole organic peroxide.

Moreover, the results with Composition 3 show that an excessive ratio of organic peroxide B to organic peroxide A leads to a significant loss in crosslinking density.

Hence, the results show that the composition according to the present invention makes it possible to delay scorching during the crosslinking of the EPDM composition without a harmful effect on the final crosslinking density.

### Example 2

The protocol described in example 1 was repeated, except that an isomer mixture of 1,3 and 1,4-bis(tert-butylperoxyisopropyl)-benzene was used as the Component A.

TABLE 3
Peroxide Formulation Testing of TABLE 1 EPDM Masterbatch

| | Composition 4 | Composition 5 |
|---|---|---|
| RATIOS | | |
| C/A | 0.044 | 0.044 |
| B/A | 0.000 | 0.016 |
| COMPOSITION (phr) | | |
| EPDM MB (g) | 244 | 244 |
| A - an organic peroxide, 1,3 and | 3.2 | 3.15 |
| 1,4-BIS(TERT- | | |
| BUTYLPEROXYISOPROPYL)- | | |
| BENZENE (CAS: 25155-25-3) | | |
| B - an unsaturated organic | 0.00 | 0.05 |
| peroxide, 1-(2-tert- | | |
| butylperoxyisopropyl)-3- | | |
| isopropenylbenzene, | | |
| C - a nitroxide (4-hydroxy- | 0.14 | 0.14 |
| TEMPO) | | |
| Ts05 - MOONEY SCORCH at | 13:54 | 16:19 |
| 135° C. | | |
| change vs reference (%) | | 17% |
| RPA at 190° C. MH − ML | 24.1 | 24.0 |
| change vs reference (%) | | 0% |

Example 2 shows an improvement in scorch time value without significant change in the rheometric crosslinking density also when organic peroxide A is 1,3 and 1,4-bis(tert-butylperoxyisopropyl)-benzene (CAS: 25155-25-3) and when the mixture comprises the component B.

### Example 3

The protocol described in example 1 was repeated, except that Luperox® 231 from Arkema (1,1-di-(tert-butylperoxy)-3,3,5-trimethylcyclohexane) was used as Component A.

TABLE 4

| | Compo- | Compo- | Compo- |
|---|---|---|---|
| | sition 6 | sition 7 | sition 8 |
| RATIOS | | | |
| C/A | 0.04 | 0.04 | 0.06 |
| B/A | 0.000 | 0.011 | 0.500 |
| COMPOSITION (phr) | | | |
| EPDM MB (g) | 244 | 244 | 244 |
| A - an organic peroxide, 1,1-di-(tert- | 4.8 | 4.75 | 3.2 |
| butylperoxy)-3,3,5- | | | |
| trimethylcyclohexane | | | |
| B - an unsaturated organic peroxide, | 0 | 0.05 | 1.6 |
| 1-(2-tert-butylperoxyisopropyl)- | | | |
| 3-isopropenylbenzene, | | | |
| C - a nitroxide (4-hydroxy-TEMPO) | 0.2 | 0.2 | 0.2 |
| Ts05 - MOONEY SCORCH at 110° C. | 16:56 | 19:23 | 22:44 |
| change vs reference (%) | | 14% | 34% |
| RPA at 165° C. MH − ML | 16.8 | 16.4 | 12.32 |
| change vs reference (%) | | −2% | −27% |

Example 3 shows an improvement in scorch time value without significant change in the rheometric crosslinking density also when organic peroxide A is 1,1-di-(tert-butylperoxy)-3,3,5-trimethylcyclohexane (CAS: 6731-36-8) and when the mixture comprises component B.

The results with Composition 8 show that an excessive ratio of organic peroxide B to organic peroxide A leads to a significant loss in crosslinking density.

These results confirm that the composition according to the present invention makes it possible to delay scorching during the crosslinking of the EPDM composition without a harmful effect on the final crosslinking density.

1-13. (canceled)

15. A composition comprising:
a) at least one organic peroxide (a) chosen among the group consisting of dialkyl peroxides, peroxyketals and mixtures thereof,
b) at least one organic peroxide (b) comprising in its structure at least one unsaturated side chain, said organic peroxide (b) being different to the organic peroxide (a),
c) at least one nitroxide,
wherein the weight ratio between the organic peroxide (b) and the organic peroxide (a) ranges from 0.003 to 0.04.

16. The composition according to claim 15, characterized in that said weight ratio between the organic peroxide (b) and the organic peroxide (a) ranges from 0.005 to 0.03.

17. The composition according to claim 15, characterized in that the dialkyl peroxides are selected from the compounds having the following formula (II): 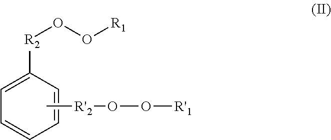
wherein:
R₁ and R′₁, independently from one another, represent a linear or a branched C₃-C₁₀ alkyl radical,
R₂ and R′₂, independently from one another, represent a linear or a branched C₃-C₁₀ alkyl radical.

18. The composition according to claim 15, characterized in that the dialkyl peroxides are chosen among the group consisting of dicumyl peroxide, 1,3-bis(tert-butylperoxyisopropyl)-benzene, 2,5-dimethyl-2,5-di(t-butylperoxy)hexane, 1,4-bis(tert-butylperoxyisopropyl)-benzene, and mixtures thereof.

19. The composition according to claim 15, characterized in that the peroxyketals are chosen among the group consisting of 1,1-di(t-butylperoxy)-3,3,5-trimethylcyclohexane; 1,1-di(t-butylperoxy)cyclohexane; n-butyl 4,4-di(t-amylperoxy)valerate; ethyl 3,3-di(t-butylperoxy)butyrate; 2,2-di(t-amylperoxy)propane; 3,6,6,9,9-pentamethyl-3-ethoxycarbonylmethyl-1,2,4,5-tetraoxacyclononane; n-butyl-4,4-bis(t-butylperoxy)valerate; ethyl-3,3-di(t-amylperoxy)butyrate; and mixtures thereof.

20. The composition according to claim 15, characterized in that said organic peroxide (b) can be chosen among the compounds having the following formula (III) or (IV):
[Chem 3]
R₆—O—O—R₆′ (III)
or
R₆′—O—O—R₆′ (IV)
Wherein:
R₆ represents a linear or branched C₃-C₁₀ alkyl group
R′₆ represents a linear or branched C₂-C₁₂ alkyl group:
substituted with at least one aromatic ring, or
substituted with at least one side chain.

21. The composition according to claim 15, characterized in that said organic peroxide (b) is 1-(2-tert-butylperoxyisopropyl)-3-isopropenylbenzene.

22. The composition according to claim 15, characterized in that the at least one nitroxide is chosen among the group consisting of 2,2,6,6-tetramethylpiperidin-1-oxyl, 4-hydroxy-2,2,6,6-tetramethylpiperidinoxyl, 4-methoxy-2,2,6,6-tetramethylpiperidin-1-oxyl, 4-oxo-2,2,6,6-tetramethylpiperidin-1-oxyl, 2,2,5,5-tetramethylpyrrolidin-loxyl, bis(1-oxyl-2,2,6,6-tetramethyl-piperidin-4-yl) sebacate, 1-piperidinyloxy-4,4′-(1,10-dioxo-1,10-decanediyl)bis(oxy))bis(2,2,6,6-tetramethyl-), 2,2,6,6-tetramethyl 1-4-hydroxypiperidin-1-oxyl monophosphonate, 3-carboxy-2,2,5,5-tetramethylpyrrolidinyloxy and mixtures thereof.

23. The composition according to claim 15, characterized in that it further comprises at least one crosslinkable polymer.

24. The composition according to claim 23 characterized, in that the crosslinkable polymer is selected among the group consisting of low density linear polyethylene, low density poly-ethylene, high density polyethylene, chlorinated polyethylene, ethylene-propylene-diene terpolymers (EPDM), ethylene-vinyl acetate copolymers, ethylene-propylene copolymers, ethylene-butene copolymers, ethylene-octene copolymers, ethylene-butyl acrylate copolymers (EBA), ethylene-methyl acrylate copolymers (EMA), ethylene-ethyl acrylate copolymers (EBA), silicone rubber, natural rubber (NR), polyisoprene (IR), polybutadiene (BR), acrylonitrile-butadiene copolymers (NBR), styrene-butadiene copolymers (SBR), neoprene rubber (CR), acrylonitrile-butadiene-styrene (ABS), styrene-butadiene-styrene block copolymers (SBS), chlorosulfonated polyethylene, fluoro elastomers, copolymers of ethylene and methyl (meth)acrylate and copolymers of ethylene and glycidyl methacrylate and combinations thereof.

25. A method for manufacturing a composition comprising mixing:
a) at least one organic peroxide (a) chosen among the group consisting of dialkyl peroxides, peroxyketals and mixtures thereof, said peroxide (a) being as defined according to claim 15,
b) at least one organic peroxide (b) comprising in its structure at least one unsaturated side chain, said organic peroxide (b) being different to the organic peroxide (a), said peroxide (b) being as defined according to claim 15, and
c) a nitroxide as defined according to claim 15,
wherein the weight ratio between said organic peroxide (b) and said organic peroxide (a) ranges from 0.003 to 0.04.

26. A method for crosslinking at least one crosslinkable composition comprising at least one crosslinkable polymer as defined in claim 23 comprising: a step of crosslinking said crosslinkable composition in the presence of a composition as defined in claim 15.
